(19) United States
(12) Patent Application Publication
(10) Pub. No.: US 2017/0079473 A1
(43) Pub. Date: Mar. 23, 2017

(54) OVEN FOR HEATING FOOD

(71) Applicant: DUKE MANUFACTURING CO., Saint Louis, MO (US)

(72) Inventor: James W. Bigott, Fenton, MO (US)

(21) Appl. No.: 15/369,346

(22) Filed: Dec. 5, 2016

Related U.S. Application Data
(63) Continuation of application No. PCT/IB2015/054397, filed on Jun. 10, 2015.
(60) Provisional application No. 62/010,289, filed on Jun. 10, 2014.
(60) Provisional application No. 62/029,887, filed on Jul. 28, 2014.

(51) Int. Cl. A47J 36/24; A47J 39/00; F24C 15/32

(52) U.S. Cl. CPC A47J 36/24; F24C 15/322; A47J 39/003

(57) ABSTRACT

Systems, apparatus, and methods for heating food. In one embodiment, an oven includes a heating compartment sized for receiving food to be heated. A heater system of the oven heats gas for heating the food. A blower system of the oven blows heated gas into the heating compartment. A gas flow inlet and a gas flow exhaust are arranged for providing a flow of heated gas in the heating compartment. In one embodiment, a filter is used for filtering gas from the heating compartment.

### CROSS-REFERENCE TO RELATED APPLICATION

This application is a continuation of PCT Application No. PCT/IB2015/054397, filed Jun. 10, 2015, which claims the benefit of U.S. Provisional Application No. 62/010,289, filed Jun. 10, 2014, and U.S. Provisional Application No. 62/029,887, filed Jul. 28, 2014.

### FIELD OF THE DISCLOSURE

The present invention generally relates to food serving equipment, and more particularly to an oven for heating food.

### BACKGROUND

In one embodiment, this invention is directed to an oven that uses hot gas to maintain pre-cooked food at proper temperatures before serving. This type of equipment is often referred to using such names as a holding oven, or a holding unit, or a food warmer. Such equipment is used in the fast food service industry to heat food prior to serving it.

### SUMMARY

One aspect of the present invention is directed to an oven for heating food. The oven includes a heating compartment sized for receiving the food. The heating compartment has a first side wall, a bottom wall, and an open top in open communication with a surrounding environment outside the oven. The first side wall includes a gas flow inlet having an upper end and a lower end. The oven includes a heater system for heating gas. The oven includes a blower system for blowing the heated gas through said gas flow inlet into the heating compartment. The bottom wall includes a first bottom wall portion substantially free of exhaust gas flow openings and a second bottom wall portion defining a gas flow exhaust having a front end toward the gas flow inlet and an opposite rear end. The first bottom wall portion is positioned between the gas flow inlet and the gas flow exhaust. The first bottom wall portion has a length corresponding to a horizontal distance between the lower end of the gas flow inlet and the front end of the gas flow exhaust. The length of the first bottom wall portion is at least about 20% of the horizontal distance from the lower end of the gas flow inlet to the rear end of the gas flow exhaust. Gas blows into the heating compartment via the gas flow inlet in the first side wall, flows above the first bottom wall portion, and exhausts from the heating compartment via the gas flow exhaust in the second bottom wall portion.

Another aspect of the present invention is directed to an oven for heating food. The oven includes a heating compartment sized for receiving the food. The heating compartment has a first side wall, a bottom wall, and an open top in open communication with a surrounding environment outside the oven. The first side wall includes a gas flow inlet. The oven includes a heater system for heating gas. The oven includes a blower system for blowing the heated gas through said gas flow inlet into the heating compartment. The bottom wall includes a gas flow exhaust. Gas blows into the heating compartment via the gas flow inlet in the first side wall and exhausts from the heating compartment via said gas flow exhaust in the bottom wall. A return plenum below the heating compartment is provided for receiving gas from the heating compartment via the gas flow exhaust. The return plenum includes an outlet for delivering gas to the blower system. A filter overlies the return plenum outlet for filtering gas supplied from the return plenum to the blower.

Other objects and features of the present invention will be in part apparent and in part pointed out herein.

### BRIEF DESCRIPTION OF THE DRAWINGS

FIG. 1 is a front perspective of one embodiment of an oven embodying aspects of the present invention

FIG. 2 is a rear perspective of the oven of FIG. 1;

FIG. 3 is an exploded front perspective of the oven;

FIG. 4 is a perspective of a food support of the oven;

FIG. 5 is a perspective of a gas flow divider of the oven;

FIG. 6 is a is a perspective of a catch pan of the oven;

FIG. 7 is a perspective of a food holding assembly of the oven;

FIG. 8 is a section of the food holding assembly of FIG. 7;

FIG. 9 is a perspective of a receptacle of the oven; and

FIG. 10 is a section of the oven including a schematic illustration of gas flow through the oven.

Corresponding reference characters indicate corresponding parts throughout the drawings.

### DETAILED DESCRIPTION

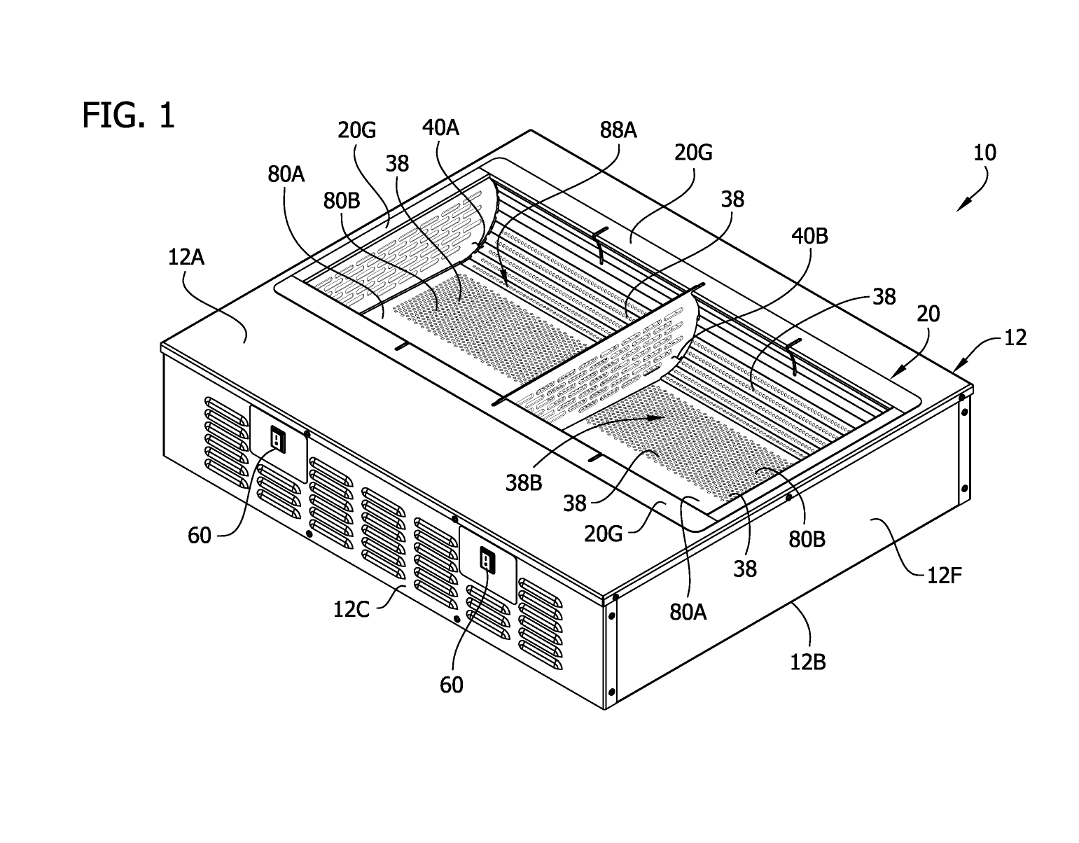

Referring to FIGS. 1-3, an oven according to the present invention is designated in its entirety by the reference number 10. The oven is configured for heating food with heated gas (e.g., air). For example, the oven 10 may be referred to as a food holding oven for maintaining cooked food in a warm condition before it is served. The oven 10 may be used for heating various types of food, such as potato fries, onion rings, and other fried foods or non-fried foods.

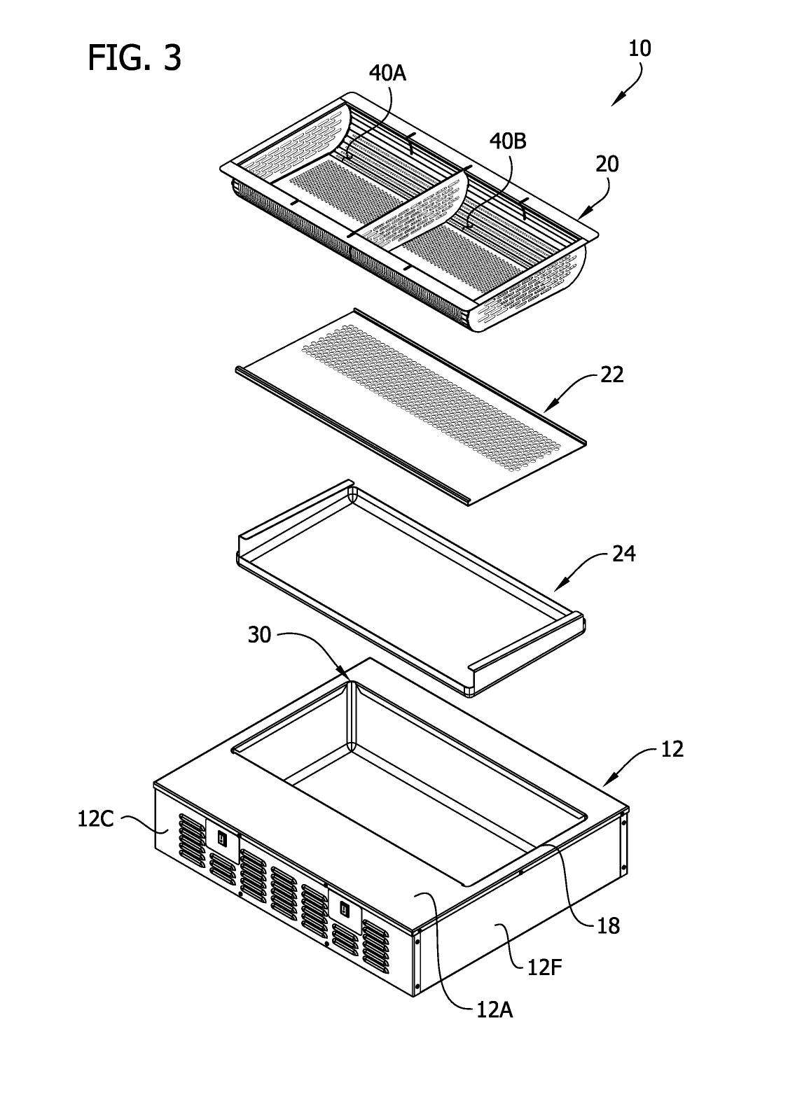

The oven 10 includes a housing, generally designated 12, having an interior bounded by a plurality of walls, including an upper wall 12A, a bottom wall 12B, front and back side walls 12C, 12D, and left and right side walls 12E, 12F. The housing 12 has a width extending between the left and right side walls 12E, 12F, and a length extending between the front and back walls 12C, 12D. The housing 12 includes an upper opening 18 (FIG. 3), which in the illustrated embodiment is provided in the upper wall 12A. The housing includes front and back housing sections positioned in front of and behind the opening 18, respectively. The front and back housing sections extend widthwise of the housing between the left and right sides 12E, 12F of the housing 12. As will become apparent, equipment for blowing and/or heating gas may be supported in the front housing section.

Referring to FIG. 3, several components of the oven 10 are shown removed from the housing 12. These components include a food support 20, a gas flow divider 22, and a catch pan 24. In general, and as will be described in further detail below, heated gas is delivered to food supported on the food support 20, the gas is exhausted through a bottom of the food support, and the gas is re-heated and re-circulated to the food on the food support. Particles and oil may fall from the food through the food support 20 and are collected on the divider 22 and/or catch pan 24 for disposal. Desirably, the food support 20, divider 22, and catch pan 24 are removable from the housing 12 via the upper opening 18 in the housing. The oven 10 includes an open-top receptacle 30 in the housing 12 defining a cavity extending downward from the upper opening 18 for receiving the catch pan 24, the divider 22, and the food support 20. Other arrangements may be used without departing from the scope of the present invention. For example, the food support 20, divider 22, and/or catch pan 24 may not be removable or may be removable in other ways, without departing from the scope of the present invention. Moreover, components such as the receptacle 30, divider 22, and catch pan 24 may be omitted without departing from the scope of the present invention. The various components will be described in further detail below.

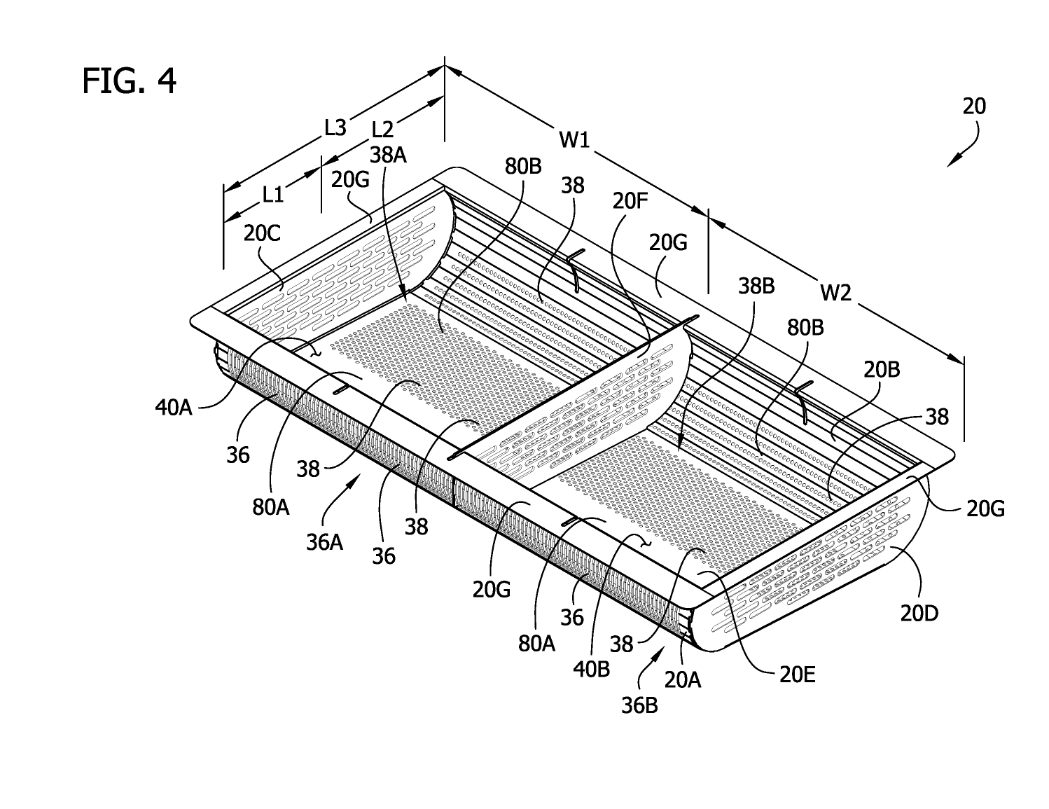

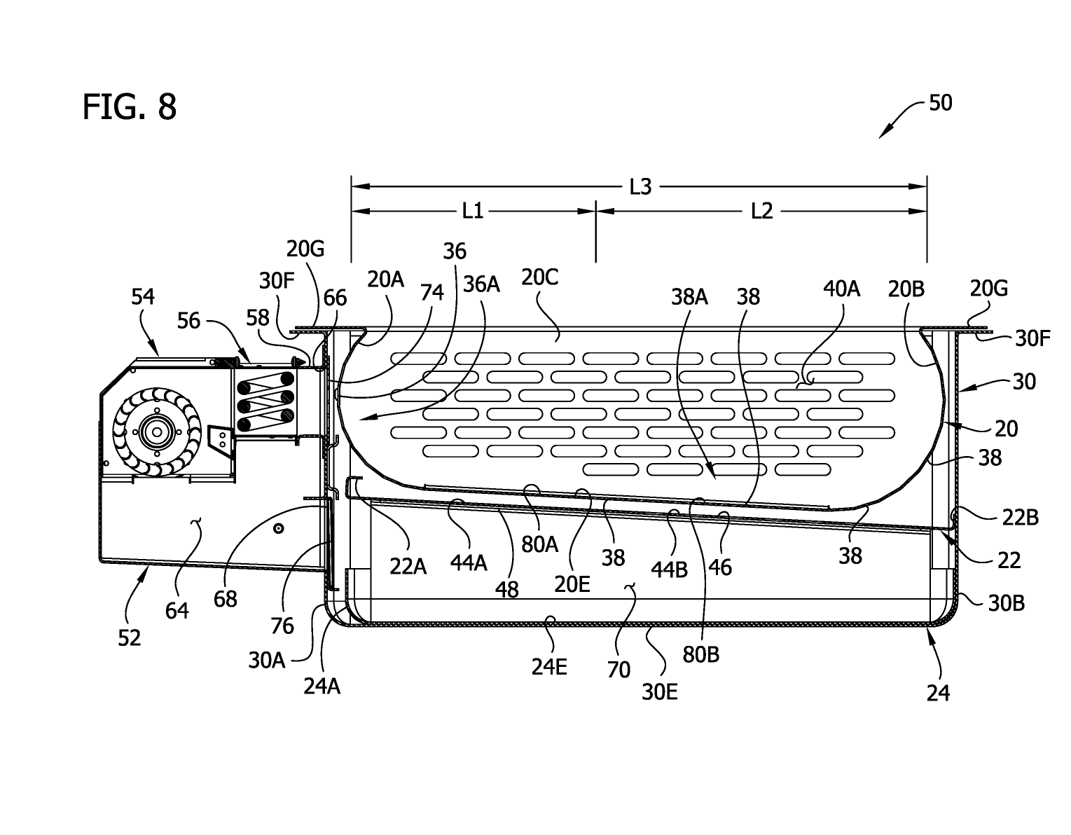

As shown in FIGS. 4 and 8, in the illustrated embodiment, the food support 20 comprises a basket-shaped member including a front side wall 20A, a rear side wall 20B, left and right side walls 20C, 20D, and a bottom wall 20E. The food support 20 may be fabricated from suitable material (e.g., stainless steel) as a single part or from multiple parts secured together. The bottom wall 20E includes a front end connected to the front side wall 20A, a rear end connected to the back side wall 20B, and left and right ends connected to the left and right side walls 20C, 20D, respectively. The bottom wall 20E comprises a substantially smooth planar region and substantially smooth forward and back regions curving upward from the planar region, which facilitates scooping food out of the food support. The planar region extends downward and away from the front wall 20A toward the back wall 20B. The front and back walls 20A, 20B extend upward from the forward and back curved regions of the bottom wall 20E. The front wall 20A includes an upper region that curves toward the back wall, and the back wall 20B includes an upper region that curves toward the front wall. The curved upper region of the back wall 20B may act as a gas flow deflector, as explained in further detail below. The front and rear walls 20A, 20B may have configurations other than illustrated herein without departing from the scope of the present invention. The left and right side walls 20C, 20D extend upward from the bottom wall 20E and extend between the front and back walls 20A, 20B to close the left and right sides of the food support 20. An intermediate wall or partition 20F between the left and right side walls 20C, 20D extends upward from the bottom wall 20E and extends between the front and back walls 20A, 20B. The bottom wall 20E, front side wall 20A, and partition 20F include gas flow openings or perforations 36, 38 to permit gas flow through the walls and/or to permit particles (e.g., salt or crumbs) and oil to pass through the walls. The gas flow openings 36 in the front side wall 20A comprise inlet gas flow openings having a generally elongate or slot shape extending vertically along the front side wall. The gas flow openings 38 in the bottom wall comprise exhaust gas flow openings having a generally circular shape. As explained in further detail below, the inlet gas flow openings 36 define respective gas flow inlets 36A, 36B, and the exhaust gas flow openings 38 define respective gas flow exhausts 38A, 38B. Other shapes and arrangements of gas flow openings may be used without departing from the scope of the present invention. The arrangement of gas flow openings 38 in the bottom wall 20E promotes desired flow of heated gas across the food supported on the bottom wall, as will become apparent.

The food support 20 includes flanges 20G at upper ends of the front side wall 20A, back side wall 20B, and left and right side walls 20C, 20D. The flanges 20G overlie edge margins of the upper wall 12A of the housing 12 around the opening 18. The flanges 20G support the food support 20 in the receptacle 30. Other mounting arrangements for the food support 20 may be used without departing from the scope of the present invention.

The oven 10 includes an open top oven cavity formed by the bottom wall 20E and front, back, left, and right side walls 20A-20D of the food support 20. The oven cavity includes separate open top heating compartments or “lanes” 40A, 40B which are partitioned from each other by the food support partition 20F. In the illustrated embodiment, two heating compartments are provided, namely, a first or left heating compartment 40A, and a second or right heating compartment 40B. Other numbers of heating compartments (e.g., one, three, four, or more heating compartments) may be provided without departing from the scope of the present invention. In the illustrated embodiment, the heating compartments 40A, 40B are arranged in a row extending widthwise of the housing 12 between the left and right sides of the housing.

The open top heating compartments 40A, 40B are defined by walls and/or respective portions of walls of the food support 20. More particularly, the heating compartments 40A, 40B are defined by respective portions of the front wall 20A, back wall 20B, bottom wall 20E, respective left and right side walls 20C, 20D, and the partition 20F of the food support. The left heating compartment 40A includes left and right side walls defined by the left side wall 20C of the food support 20 and the partition 20F, front and back side walls defined by respective left portions of the front and back side walls 20A, 20B of the food support, and a bottom wall including a food support surface defined by a left portion of the bottom wall 20E of the food support. The right heating compartment 40B includes left and right side walls defined by the partition 20F and the right side wall 20D of the food support 20, front and back side walls defined by respective right portions of the front and back side walls 20A, 20B of the food support, and a bottom wall including a food support surface defined by a right portion of the bottom wall 20E of the food support. The inlet gas flow openings 36 in the left side of the front wall 20A collectively define the gas flow inlet 36A for the left heating compartment 40A, and the inlet gas flow openings 36 in the right side of the front wall 20A form the gas flow inlet 36A for the right heating compartment 40B. The gas flow inlets 36A, 36B have upper ends defined by the uppermost gas flow openings 36 of the inlets and lower ends defined by the lowermost gas flow openings of the inlets. The exhaust gas flow openings 38 in the left side of the bottom wall 20E collectively define the gas flow exhaust 38A for the left heating compartment 40A, and the exhaust gas flow openings 38 in the right side of the bottom wall 20E collectively define the gas flow exhaust 38B for the right heating compartment 40B. The gas flow exhausts have front ends defined by the exhaust gas flow openings 38 closest to the gas flow inlets and rear ends defined by the exhaust gas flow openings farthest from the gas flow inlets.

Food is supported in each heating compartment 40A, 40B on its respective food support surface. The food support surfaces, comprising respective left and right portions of the planar region and the forward and back upwardly curved regions of the food support bottom wall 20E, are substantially smooth and continuous for facilitating removal of food from the heating compartments 40A, 40B. The removal of food can be carried out with a scoop (or similar implement) and/or a food package (e.g., a carton) using a scooping motion to transfer food from the food support surfaces to the scoop and/or package. As food is pushed in a front-to-back or back-to-front direction along the food support surface of a particular heating compartment 40A, 40B, food on the upwardly curved regions of the food support surfaces and the front or back side walls of the heating compartments tends to gravitate down into the scoop or package to fill it. The gas flow openings or perforations 36, 38 in the food support permit salt and other food particles to pass through the food support surfaces and permit gas to flow through the food support surfaces.

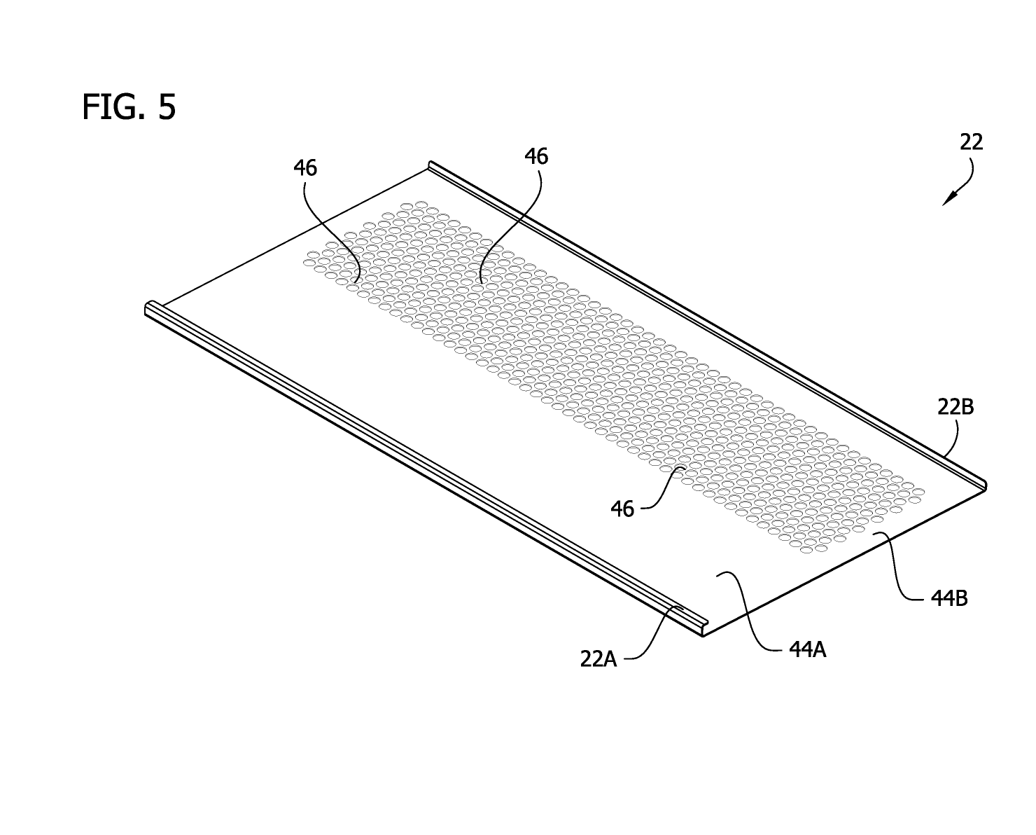

Referring to FIG. 5, the gas flow divider 22 comprises a generally rectangular wall including a generally planar region having front and back ends, left and right ends, a length extending between the front and back ends, and a width extending between the left and right ends. Front and rear flanges 22A, 22B are provided on the front and back ends, respectively. The generally planar region includes a first non-perforated region 44A adjacent the front end of the gas flow divider, and a second region 44B having a gas flow passage comprising multiple gas flow openings 46 adjacent the rear end of the gas flow divider 22. The first non-perforated region 44A prevents gas flow through gas flow divider 22, and the second perforated region 44B permits gas flow through the divider. The gas flow divider 22 assists in controlling the gas flow in the oven, as will become apparent. The gas flow divider 22 may have other configurations or be omitted without departing from the scope of the present invention.

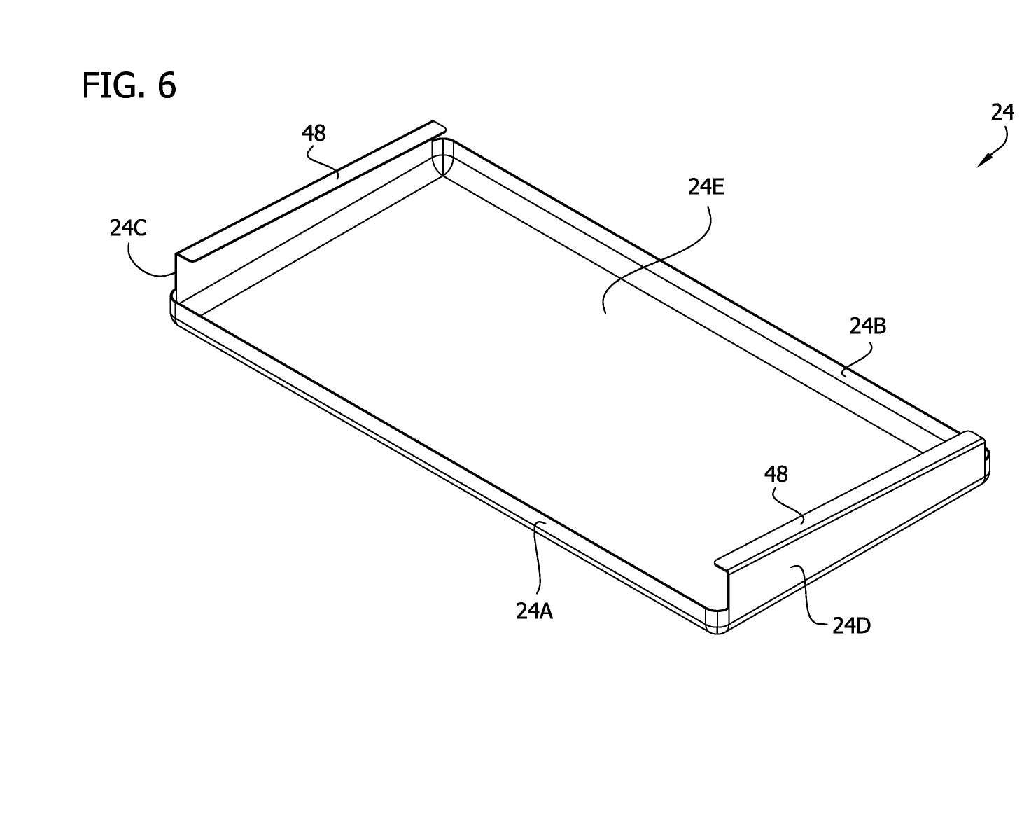

As shown in FIG. 6, the catch pan 24 is configured for catching particles (e.g., salt and food particles) and oil or other liquids which may fall through the food support 20 and gas flow divider 22. The catch pan 24 includes upstanding peripheral walls, including a front wall 24A, back wall 24B, left wall 24C, and right wall 24D, and a non-perforated bottom wall 24E. The left and right side walls 24C, 24D include inwardly turned flanges 48 for supporting the gas flow divider 22 above the catch pan 24. The front wall 24A is relatively short to permit gas flow over the front wall, as will become apparent. The catch pan 24 may be removed from the receptacle 30 via the upper opening 18 in the housing, as shown in FIG. 3, for emptying the contents of the catch pan. Other types of catch pans or other arrangements for collecting and removing the particles and/or oil may be used without departing from the scope of the present invention.

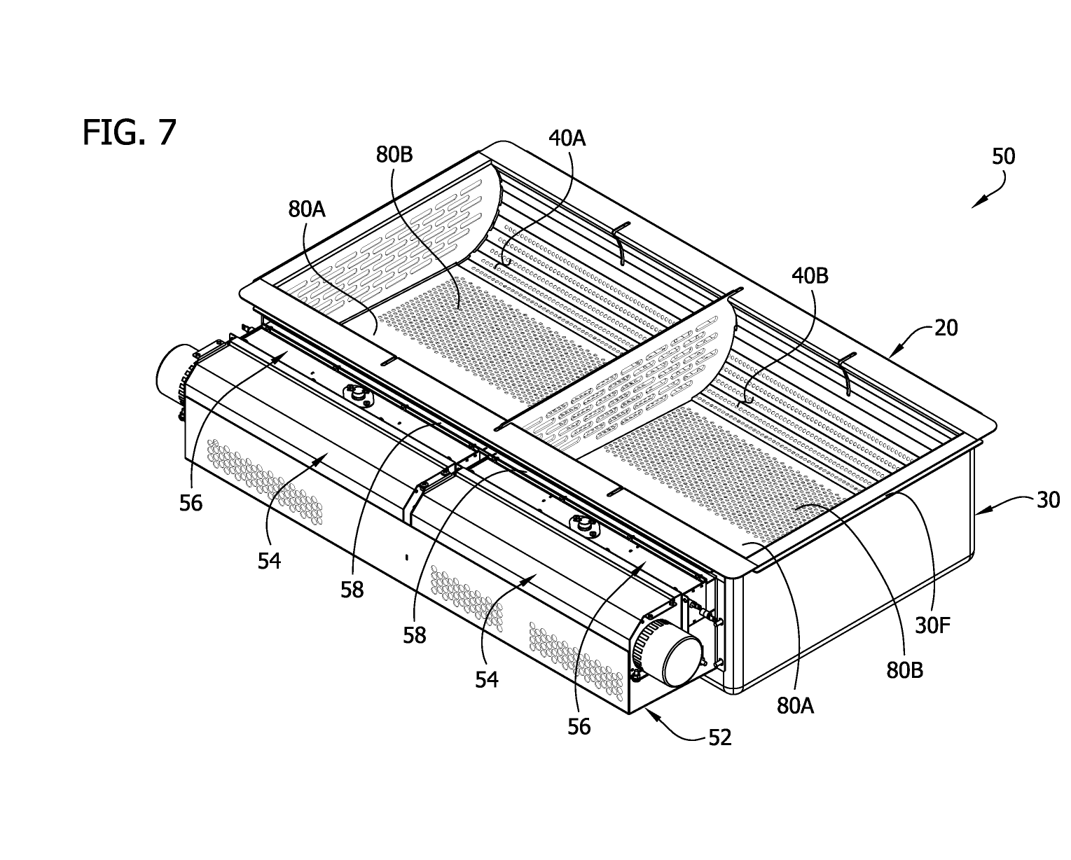

Referring now to FIGS. 7 and 8, a food holding assembly 50 is shown removed from the housing 12. The food holding assembly 50 includes several components previously described, including the food support 20, the divider 22, the catch pan 24, and the receptacle 30. In addition, the food holding assembly 50 includes a frame or plenum housing 52, first and second blower systems 54, first and second heater systems 56, and relatively small ducts 58 providing gas flow passageways to the heating compartments 40A, 40B. The blower and heater systems 54, 56 are connected to and supported by the receptacle 30. The blower systems 54 blow gas into respective heating compartments, and the heater systems 56 heat the gas blown into the heating compartments. The blower and heater systems 54, 56 can be selectively turned on and off using switches 60 (FIG. 1) on the front of the housing 12. In the illustrated embodiment, the first blower system 54 is associated with the left heating compartment 40A, the second blower system 54 is associated with the right heating compartment 40B, and each blower system 54 includes one blower, also numbered 54. The blowers 54 may be variable speed or single speed tangential blowers. The blower systems may include other types and numbers of blowers without departing from the scope of the present invention. The first heater system 56 is associated with the left heating compartment 40A, the second heater system 56 is associated with the right heating compartment 40B, and each heater system includes one heater, also numbered 56. The heaters 56 are associated with respective blowers 54. The heaters 56 may be electric heaters with open coil heating elements capable of delivering substantial heat quickly to the gas passing by the heating elements. Other types of heaters, including finned heaters, may be used without departing from the scope of the present invention.

Referring to FIG. 8, the food holding assembly 50 is shown in section along the length of the left heating compartment 40A. Although only the left heating compartment 40A is shown in section, it will be understood that the right heating compartment 40B and associated components have a similar arrangement. As shown in FIG. 8, the blower 54 is connected to the heater 56, which is connected to the receptacle 30 by the duct 58, for delivering heated gas to the left heating compartment 40A. The blower 54 and heater 58 are also supported on the frame or plenum housing 52, which is secured to the receptacle 30. The plenum housing 52 houses a blower supply plenum 64 below the blower 54 for supplying the blower with gas.

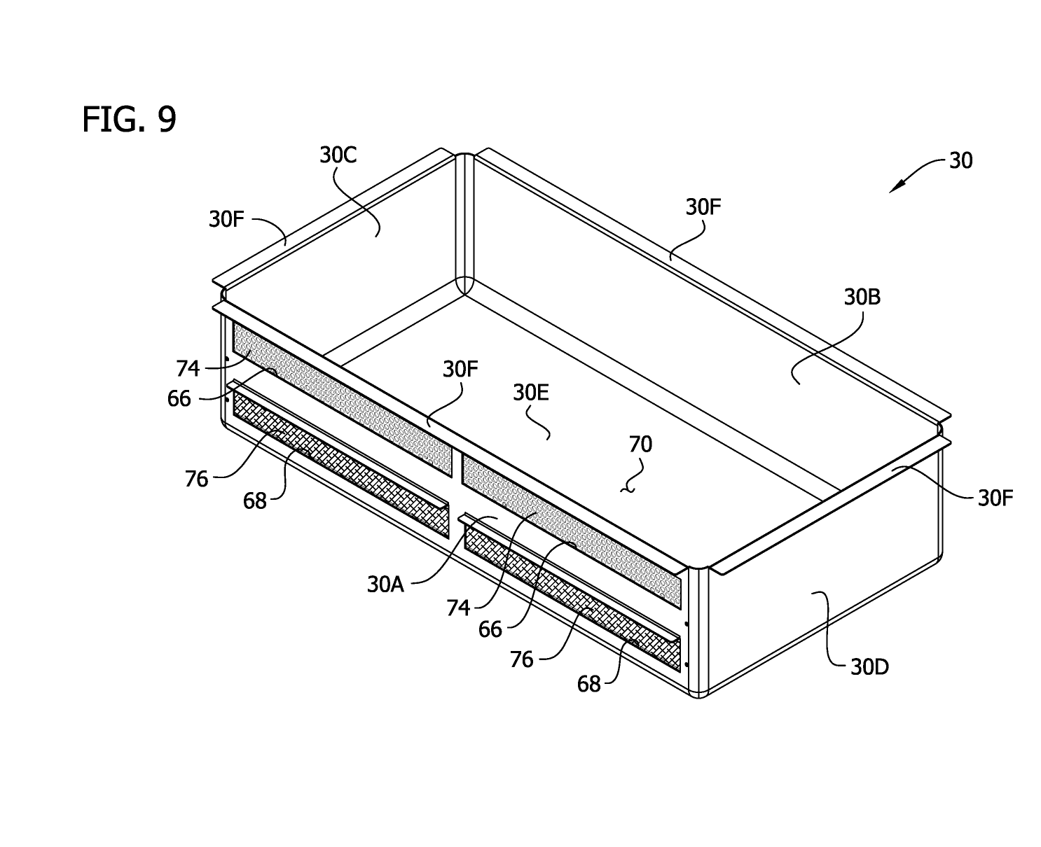

The receptacle 30 is shown more clearly in FIG. 9. In the illustrated embodiment, the receptacle 30 comprises a pan-shaped member. The receptacle may be formed of any suitable material, including sheet metal and plastic materials. In the illustrated embodiment, the receptacle 30 is formed as a single piece and includes an upstanding peripheral wall, including front and back side walls 30A, 30B, left and right side walls 30C, 30D, and a bottom wall 30E. The receptacle 30 includes flanges 30F at upper ends of the front wall 30A, back wall 30B, and side walls 30C, 30D. The flanges 30F underlie edge margins of the upper wall of the housing 12 around the opening 18 and are secured thereto in a suitable fashion (e.g., welding). The left wall 30C, right wall 30D, back wall 30B, and bottom wall 30E are non-perforated for preventing gas flow. The front wall 30A includes gas flow openings 66, 68, as explained in further detail below. The receptacle 30 forms interior portions of the housing 12. For example, the front wall 30A of the receptacle 30 forms an inner wall of the front housing section. The receptacle 30 defines a cavity for receiving the catch pan 24, divider 22, and food support 20. Moreover, a lower end of the receptacle 30 at least partially forms a gas return plenum 70 for receiving gas exiting the heating compartments 40A, 40B through the bottom wall 20E of the food support 20. As shown in FIG. 8, the return plenum 70 is positioned below the bottom wall 20E of the food support 20. Gas passes through the gas flow openings 46 of the gas flow divider 22 into the return plenum 70. The receptacle 30 may have other configurations without departing from the scope of the present invention. For example, the receptacle 30 may be formed of several pieces connected together and/or separate pieces not connected together but mounted with respect to each other to form the receptacle.

Referring again to FIG. 9, the receptacle front wall 30A includes sets of upper and lower openings 66, 68, each set being associated with a respective heating compartment 40A, 40B. In each set, the upper opening 66 defines a gas delivery outlet for delivering gas into the respective heating compartment 40A, 40B, and the lower opening 68 defines a gas return passage for returning gas to the blower supply plenum 64 from the return plenum 70. The gas return passage 68 defines an outlet of the return plenum 70 and an inlet of the blower supply plenum 64. As shown in FIG. 8, the gas flow divider 22 extends across the cavity of the receptacle 30 at a vertical location between the upper and lower openings 66, 68 to assist in preventing short-circuiting of gas flow from the gas delivery outlet 66 to the gas return passage 68. More specifically, the non-perforated region 44A of the gas flow divider 22 adjacent the front wall of the receptacle blocks direct flow of gas from the gas flow outlet 66 to the gas return passage 68, and the perforated region 44B of the gas flow divider below the gas flow openings 38 of the food support permit gas flow from the food support into the return plenum 70.

Gas discharge plates 74 are removably mounted on the receptacle front wall 30A and cover or overlie the gas delivery outlets 66. The gas discharge plates 74 include a plurality of gas flow openings. The configuration of the gas flow openings (e.g., size, number, shape, spacing, etc.) may be selected to provide desired gas flow into the heating compartments 40A, 40B. Gas exiting the gas delivery outlets 66 through the gas discharge plates 74 enters respective holding compartments 40A, 40B through the gas flow inlets 36A, 36B in the front wall 20A of the food support 20. Other types of gas discharge plates may be used, and the gas discharge plates may be omitted without departing from the scope of the present invention.

Filters 76 are removably mounted on the receptacle front wall 30A in a generally upstanding orientation and cover or overlie the gas return passages 68. Gas exiting the gas return plenum 70 through the gas return passages 68 enters the blower supply plenum 64 through the filters 76. The filters 76 may include a suitable type of filter medium, such as a screen or mesh, of a suitable type of material, such as metal or plastic, for filtering particles and oil from the gas flow. In the illustrated embodiment, the filters 76 comprise generally rectangular frames that support a filter medium in a central opening of the frames that defines a filter gas flow area. Other types of filters, including filters with other types of filter mediums, may be used without departing from the scope of the present invention. For example, other suitable types of filters may be used, including catalysts or other devices, for cleaning the gas exhausted from the heating compartments. Alternatively, the filters 76 may be omitted without departing from the scope of the present invention.

It will be appreciated that the position and orientation of the filters 76 provides certain advantages. The filters 76 are removable (e.g., for cleaning or replacement) through the upper opening 18 in the housing 12, when the food support 20 and gas flow divider 22 are removed from the receptacle 30. The filters 76 are mounted in a position horizontally offset from the gas flow openings 38 in the bottom wall 20E of the food support 20. The filters 76 are mounted adjacent the front wall of the catch pan 24 and above the bottom wall of the catch pan. Desirably, all or substantially all of the filter gas flow area is located above the front wall of the catch pan 24 so that the front wall does not inhibit the flow of gas through the filters 76. The position of the filters 76 with respect to the gas flow openings 38 in the bottom wall 20E of the food support 20 and with respect to the catch pan 24 desirably helps maintain the filters in a relatively clean state for longer periods of operation. Food particles and oil droplets desirably fall to the catch pan 24 instead of clogging the filters 76. In the illustrated embodiment, the filters 76 are mounted horizontally offset from the catch pan 24 so the catch pan can be removed from the receptacle 30 without needing to first remove the filters.

Referring to FIG. 8, as is now apparent, the blower system 54 draws gas from the blower supply plenum 64 and delivers it to the heating compartment 40A through the gas flow inlet 36A. The heating system 56 heats the gas that is delivered to the heating compartment 40A. The heated gas heats food held on respective food support surfaces in the compartment 40A. The flow of heated gas across the food and around the food helps to hold the heat in the food, thereby extending the holding time for the food. Gas is exhausted from the heating compartment 40A downward through the food support 20, via the gas flow exhaust 36A, and passes through the gas flow divider 22 into the return plenum 70, from which the gas passes through the filter 76 at the return plenum outlet 68 into the blower supply plenum 64 for being recirculated. The recirculation of gas flow is similar for the heating compartment 40B.

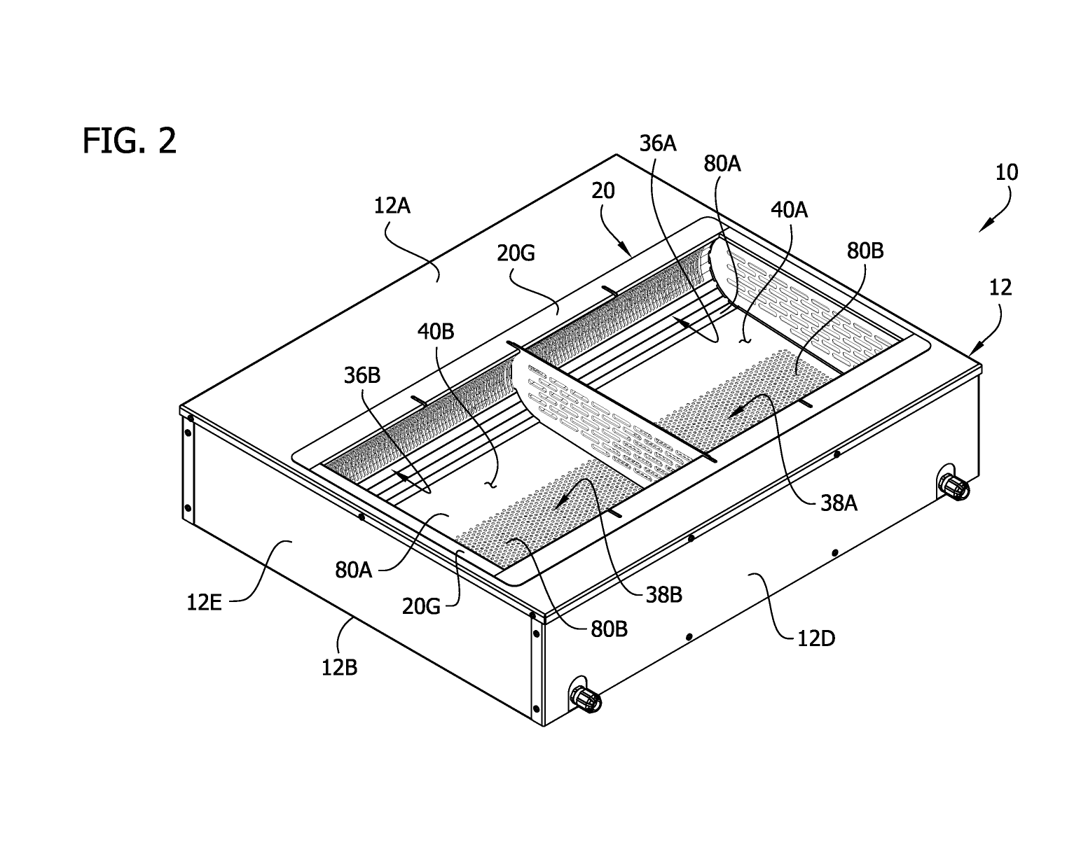

Referring again to FIGS. 4 and 8, the food support 20 is configured for providing a desired heated gas flow over and/or through the food held in the heating compartments 40A, 40B. More specifically, in each heating compartment 40A, 40B, the bottom wall 20E of the food support 20 has gas flow openings 38 of respective gas flow exhausts 38A, 38B arranged to cause the heated gas to flow over and/or through substantially all of the food held in the heating compartments before the heated gas is exhausted to the return plenum 70 through the exhausts 38A, 38B. Referring to FIG. 8, the bottom wall 20E of the heating compartment 40A includes a first bottom wall portion 80A adjacent the front side wall 20A that is substantially free of gas flow openings (e.g., non-perforated). The bottom wall 20E also includes a second bottom wall portion 80B defining the gas flow exhausts 38A, 38B for permitting gas to flow through the bottom wall. The heating compartment 40B includes similar first and second bottom wall portions 80A, 80B. The bottom wall portions 80A, 80B have respective lengths L1, L2 (FIGS. 4 and 8) extending along the length of the bottom wall and have respective widths W1, W2 (FIG. 4) extending along the width of the bottom wall 20E across respective heating compartments 40A, 40B. The lengths L1, L2 of the bottom wall portions 80A, 80B extend between the front and back side walls 20A, 20B of the food support 20, and the widths W1 of the bottom wall portions extend between respective ones of the left and right side walls 20C, 20D and the partition 20F. Referring to FIGS. 2 and 8, in the left heating compartment 40A, the first bottom wall portion 80A is positioned between the gas flow inlet 36A and the gas flow exhaust 38A. The length L1 of the first bottom wall portion 80A corresponds to a horizontal distance between the lower end of the gas flow inlet 36A and the front end of the gas flow exhaust 38A. The second bottom wall portion 80B includes part of the planar region of the bottom wall 20E, which defines a part of the gas flow exhaust 38A, and the rear upwardly curving region of the bottom wall 20E, which defines another part of the gas flow exhaust 38A. In the illustrated embodiment, the second bottom wall portion 80B has a length L2 and is shown as extending to the rear end of the bottom wall 20E. In other words, the back side wall 20B extends up from the second bottom wall portion 80B defining the exhaust 38A. However, the second bottom wall portion 80B may terminate before the back side wall without departing from the scope of the present invention.

The bottom wall portions 80A, 80B are arranged with respect to each other to substantially block flow through the bottom wall 20E adjacent the front side wall 20A and to permit flow through the bottom wall adjacent the back side wall 20B. The first and second bottom wall portions 80A, 80B are configured for preventing substantial short-circuiting of the re-circulating gas flow. In other words, the arrangement desirably causes the heated gas to flow sufficiently toward the rear end of the food support 20 before being exhausted through the bottom wall 20E such that heated gas flows over and/or through substantially all of the food in the heating compartments 40A, 40B. It will be appreciated that if gas flow openings were provided in the first bottom wall portion 80A, some gas would exhaust through those gas flow openings, possibly preventing enough heated gas from reaching food held toward the rear side of the food support 20 to keep that food warm.

Referring to FIG. 8, the length L1 of the first wall portion 80A and the length L2 of the second wall portion 80B can be expressed as a function of the horizontal distance L3 from the lower end of the gas flow inlet 36A to the rear end of the gas flow exhaust 38A. For example, desirably, the length L1 of the first bottom wall portion 80A, which is substantially free of gas flow openings, is at least about 20% of the distance L3, more desirably at least about 30% of the distance L3, and even more desirably at least about 40% of the distance L3. In the illustrated embodiment, for example without limitation, the first bottom wall portion 80A has a length L1 of about 40% of the distance L3, and the second bottom wall portion 80B has a length L2 of about 60% of the distance L3. The second bottom wall portion 80B may have a length L2 of at least about 60%, 50%, 40%, 30%, or even 20% of the distance L3. The first and second bottom wall portions may have other lengths without departing from the scope of the present invention.

Although desirably the first bottom wall portion 80A is non-perforated, it will be appreciated that the first bottom wall portion may include some exhaust gas flow openings (not shown) without departing from the scope of the present invention. However, the first bottom wall portion 80A should be “substantially free of exhaust gas flow openings,” which, as used herein, means the exhaust gas flow area per surface area of the first bottom wall portion is less than about 50% of the exhaust gas flow area per surface area of the second bottom wall portion 80B. For example, for the left heating compartment 40A, an exhaust gas flow area of the first bottom wall portion 80A can be determined by summing the exhaust gas flow areas of any exhaust gas flow openings (i.e., areas of any exhaust gas flow openings normal to flow direction) in the first bottom wall portion. The exhaust gas flow area per surface area of the first bottom wall portion 80A is determined by dividing the exhaust gas flow area of the first bottom wall portion by the surface area of the first wall portion (i.e., length L1 of the first bottom wall portion multiplied by the width W1 of the first bottom wall portion). An exhaust gas flow area of the second bottom wall portion 80B (i.e., the exhaust gas flow area of the exhaust 38A) can be determined by summing the exhaust gas flow area of the exhaust gas flow openings 38 (i.e., areas of the exhaust gas flow openings 38 normal to flow direction) in the second bottom wall portion. The exhaust gas flow area per surface area of the second bottom wall portion 80B is determined by dividing the exhaust gas flow area of the second bottom wall portion by the surface area of the second bottom wall portion (i.e., the length L2 of the second bottom wall portion 80B multiplied by the width W1 of the second bottom wall portion). The exhaust gas flow area per surface area for the first and second bottom wall portions 80A, 80B can then be compared to determine whether the exhaust gas flow area per surface area of the first bottom wall portion is less than about 50% of the exhaust gas flow area per surface area of the second bottom wall portion. More desirably, the exhaust gas flow area per surface area of the first bottom wall portion 80A is less than about 40%, more desirably less than about 30%, more desirably less than about 20%, more desirably less than about 10%, and even more desirably about 0%, of the exhaust gas flow area per surface area of the second bottom wall portion 80B. In the illustrated embodiment, for the left and right heating compartments 40A, 40B, the exhaust gas flow area per surface area of the first bottom wall portion 80A is about 0% of the exhaust gas flow area per surface area of the second bottom wall portion 80B because the first bottom wall portions are non-perforated. Other configurations (e.g., number, size, arrangement) of gas flow openings and other types of exhausts may be used without departing from the scope of the present invention.

In operation, cooked food from a cooking device, such as a fryer, is placed on the food support 20 in the left and/or right heating compartment(s) 40A, 40B. For example, sweet potato fries and onion rings may be positioned in the left and right heating compartments 40A, 40B, respectively. The food is heated in the heating compartments 40A, 40B under desired gas flow and temperature conditions by the delivery of heated gas to the heating compartments. Gas exits the heating compartments through the gas flow openings 38 in the bottom wall 20E of the food support 20 and passes through the return plenum 70, filters 76, and supply plenum 64 for recirculation to the blower and heater systems 54, 56. Desirably, food particles and oil fall to the catch pan 24, and the filters 76 remove particles and oil from the gas flow, for collection and removal. When it is desired to serve food from one of the heating compartments 40A, 40B, the food is removed from the heating compartment using a scooping motion.

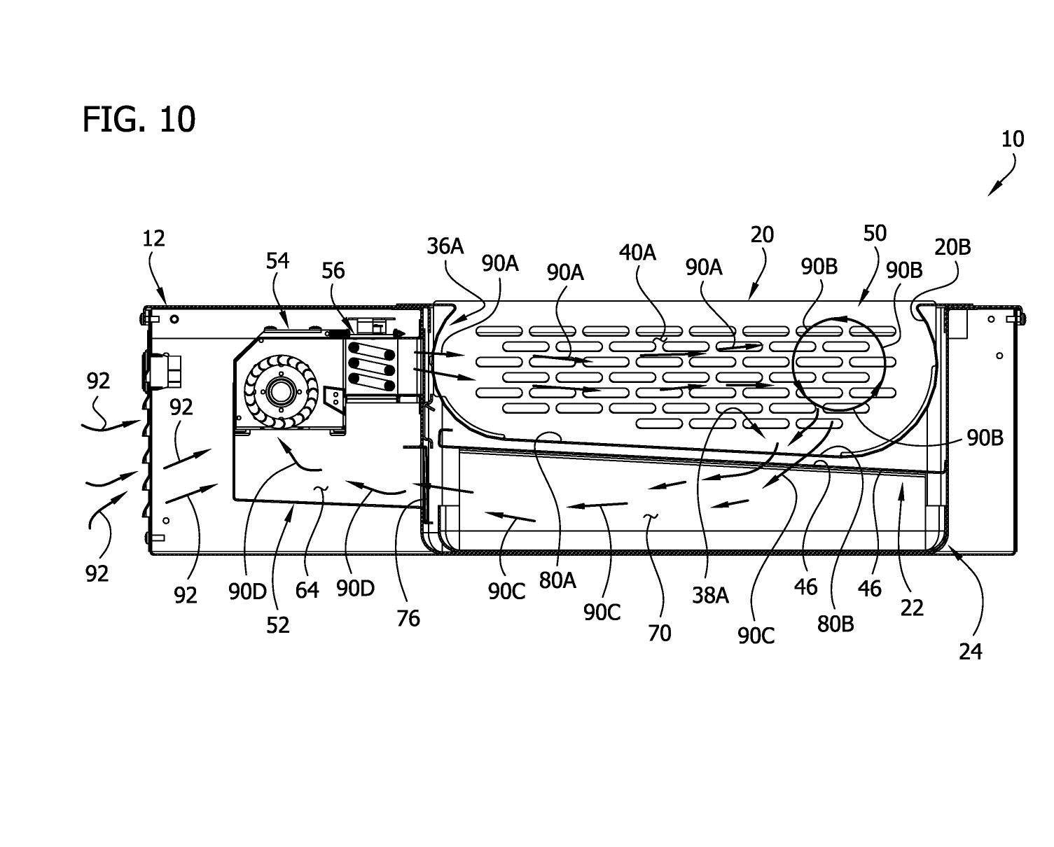

The back side wall 20B of the food support 20, the gas flow exhaust 38A, and/or the gas flow passage (gas flow openings 46) in the gas flow divider 22 can be configured and arranged with respect to each other to provide desired air flow in the heating compartment 40A. In the illustrated embodiment, the back side wall 20B is constructed to form a gas flow deflector having a surface curving toward the front side wall. The curved nature of the back side wall 20E assists in directing the heated gas flow for flowing over and/or through the food and for exhaust through the bottom wall 20E. Referring to FIG. 10, an example gas flow for the oven 10 is illustrated. This gas flow is shown by example without limitation. Other constructions and other gas flows in the oven (e.g., gas flows in the food support 20) may be used without departing from the scope of the present invention. In the example shown in FIG. 10, heated gas entering the left heating compartment 40A, as shown by arrows indicated at 90A, flows from the gas flow inlet 36A over the first bottom wall portion 80A toward the rear wall 20B of the food support. Some of the heated gas flows relatively directly to the gas flow exhaust 38A and exits the heating compartment 40A through the gas flow exhaust 38A in the bottom wall 20E. In addition, some of the gas from the gas flow inlet 36A may flow above the gas flow exhaust 38A and, as shown by arrows indicated at 90B, be deflected or directed by the gas flow deflector of the rear wall 20B upwardly. As the gas flows upwardly, the gas flow deflector also begins to deflect or direct the gas back toward the gas flow inlet 36A. Desirably, this gas is ultimately pulled downward (e.g., by negative pressure created by the blower system 54) toward the gas flow exhaust 38A and then exits the exhaust. However, some of the gas deflected by the gas flow deflector and then pulled downward toward the gas flow exhaust 38A collides with additional gas crossing the first bottom wall portion 80A from the gas flow inlet 36A, which may cause the gas to again flow toward the gas flow deflector and repeat the flow cycle. In this manner, heated gas may “tumble” in the heating compartment 40A in what may be referred to as a “heated gas scroll,” shown by arrows indicated at 90B, adjacent the gas flow deflector 20B. Some of the heated gas may recirculate in this tumbling fashion in the heated gas scroll briefly (e.g., for only one rotation) or for an extended time. The position of the gas flow exhaust 38A in the food support 20 and/or the gas flow passage in the gas flow divider 22 with respect to the back wall 20B or gas flow deflector may cause the tumbling movement of the gas in the heated gas scroll. It will be understood that the tumbling of the heated gas in the food support 20 can be beneficial because it increases the engagement of heated gas with food in the heating compartment 40A, especially adjacent the end of the heating compartment opposite the gas flow inlet 36A, where food may not otherwise be sufficiently heated because of short-circuiting of heated gas through the bottom of the food support 20. After the gas exits the heating compartment 40A through the gas flow exhaust 38A in the bottom wall 20E, the gas passes through the return plenum 70, as shown by arrows indicated at 90C, passes through the filter 76, and passes through the supply plenum 64, as shown by arrows indicated at 90D, for recirculation to the blower and heater systems 54, 56. Make-up gas from ambient, as shown by arrows indicated at 92, may enter the supply plenum 64 and be mixed with the recirculated gas. As mentioned above, other gas flows in the oven (e.g., gas flows in the food support 20) may be used without departing from the scope of the present invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. An oven for heating food, the oven comprising
a heating compartment sized for receiving the food, the heating compartment having a first side wall, a bottom wall, and an open top in open communication with a surrounding environment outside the oven,
the first side wall including a gas flow inlet having an upper end and a lower end,
a heater system for heating gas,
a blower system for blowing the heated gas through said gas flow inlet into the heating compartment,
the bottom wall including a first bottom wall portion substantially free of exhaust gas flow openings and a second bottom wall portion defining a gas flow exhaust having a front end toward the gas flow inlet and an opposite rear end, the first bottom wall portion being positioned between the gas flow inlet and the gas flow exhaust, the first bottom wall portion having a length corresponding to a horizontal distance between the lower end of the gas flow inlet and the front end of the gas flow exhaust, the length of the first bottom wall portion being at least about 20% of the horizontal distance from the lower end of the gas flow inlet to the rear end of the gas flow exhaust, and
wherein gas blows into the heating compartment via said gas flow inlet in the first side wall, flows above the first bottom wall portion, and exhausts from the heating compartment via said gas flow exhaust in the second bottom wall portion.

2. An oven as set forth in claim 1 wherein the length of the first bottom wall portion is at least about 30% of the horizontal distance from the lower end of the gas flow inlet to the rear end of the gas flow exhaust.

3. An oven as set forth in claim 2 wherein the length of the first bottom wall portion is at least about 40% of the horizontal distance from the lower end of the gas flow inlet to the rear end of the gas flow exhaust.

4. An oven as set forth in claim 1 wherein
the second bottom wall portion has a surface area, the gas flow exhaust has an exhaust gas flow area, and the second bottom wall portion has an exhaust gas flow area per surface area defined by the exhaust gas flow area divided by the surface area of the second bottom wall portion,
the first bottom wall portion has a surface area, and the first bottom wall portion has an exhaust gas flow area per surface area defined by a sum of an exhaust gas flow area of any exhaust gas flow openings in the first bottom wall portion divided by the surface area of the first bottom wall portion, and
the exhaust gas flow area per surface area of the first bottom wall portion is less than about 40% of the exhaust gas flow area per surface area of the second bottom wall portion.

5. An oven as set forth in claim 4 wherein the exhaust gas flow area per surface area of the first bottom wall portion is less than about 30% of the exhaust gas flow area per surface area of the second bottom wall portion.

6. An oven as set forth in claim 5 wherein the exhaust gas flow area per surface area of the first bottom wall portion is less than about 20% of the exhaust gas flow area per surface area of the second bottom wall portion.

7. An oven as set forth in claim 6 wherein the exhaust gas flow area per surface area of the first bottom wall portion is less than about 10% of the exhaust gas flow area per surface area of the second bottom wall portion.

8. An oven as set forth in claim 7 wherein the exhaust gas flow area per surface area of the first bottom wall portion is about 0% of the exhaust gas flow area per surface area of the second bottom wall portion.

9. An oven as set forth in claim 1 wherein the bottom wall includes a front end toward the gas flow inlet and an opposite rear end, and the rear end of the gas flow exhaust is adjacent the rear end of the bottom wall.

10. An oven as set forth in claim 1 wherein the heating compartment further comprises second and third side walls on respective opposite sides of the bottom wall, and the first and second bottom wall portions have widths extending from the second side wall to the third side wall.

11. An oven as set forth in claim 1 wherein the blower system blows gas into the heating compartment from the first side wall only.

12. An oven as set forth in claim 1 further comprising a second side wall, the first and second side walls being positioned on opposite ends of the bottom wall.

13. An oven as set forth in claim 12 wherein the second side wall extends up from the rear end of the exhaust.

14. An oven as set forth in claim 12 wherein the second side wall defines a gas flow deflector having a surface curving toward the first side wall to deflect gas flow for exhausting through the gas flow exhaust.

15. An oven as set forth in claim 1 wherein the bottom wall comprises a food support surface for supporting the food to be heated in the heating compartment.

16. An oven as set forth in claim 1 wherein the gas flow exhaust comprises multiple gas flow openings in the second bottom wall portion.

17. An oven as set forth in claim 1, further comprising
a return plenum below the heating compartment for receiving gas from the heating compartment via the gas flow exhaust, the return plenum including an outlet for delivering gas to the blower system, and
a gas filter overlying the return plenum outlet for filtering gas supplied from the return plenum to the blower.

18. An oven for heating food, the oven comprising
a heating compartment sized for receiving the food, the heating compartment having a first side wall, a bottom wall, and an open top in open communication with a surrounding environment outside the oven,
the first side wall including a gas flow inlet,
a heater system for heating gas;
a blower system for blowing the heated gas through said gas flow inlet into the heating compartment,
the bottom wall including a gas flow exhaust,
wherein gas blows into the heating compartment via said gas flow inlet in the first side wall and exhausts from the heating compartment via said gas flow exhaust in the bottom wall,
a return plenum below the heating compartment for receiving gas from the heating compartment via the gas flow exhaust, the return plenum including an outlet for delivering gas to the blower system, and
a filter overlying the return plenum outlet for filtering gas supplied from the return plenum to the blower.

19. An oven as set forth in claim 18 wherein the filter is mounted in an upstanding orientation.

20. An oven as set forth in claim 18 wherein the filter is horizontally offset from the gas flow exhaust.

21. An oven as set forth in claim 18 further comprising a catch pan below the gas flow exhaust, the filter being positioned adjacent a side of the catch pan.

22. An oven as set forth in claim 18 further comprising a blower supply plenum for supplying the blower system with gas, the blower supply plenum including an inlet in communication with the return plenum outlet for receiving gas therefrom.

23. An oven as set forth in claim 18 further comprising a housing section including a blower system outlet in communication with the gas flow inlet for delivering gas into the heating compartment, the filter being mounted below the blower system outlet.

24. An oven as set forth in claim 18 wherein the bottom wall of the heating compartment comprises a food support surface of a food support for supporting food in the first heating compartment, and the oven further comprises a receptacle configured for removably receiving the food support, the receptacle having a side wall including an opening defining the return plenum outlet, the filter overlying said opening in the receptacle side wall.
